(19) United States
(12) Patent Application Publication
(10) Pub. No.: US 2002/0144281 A1
(43) Pub. Date: Oct. 3, 2002

(54) Global multi media service system and apparatus

(76) Inventors: Yuichi Taguchi, Sunnyvale, CA (US); Kenji Takeda, Palo Alto, CA (US)

Correspondence Address: SQUIRE, SANDERS & DEMPSEY L.L.P, 600 HANSEN WAY, PALO ALTO, CA, 94304-1043, US

(21) Appl. No.: 09/823,371

(22) Filed: Mar. 30, 2001

(51) Int. Cl. H04N 7/173; H04N 7/10

(52) U.S. Cl. 725/109; 725/110; 725/112; 725/34; 725/35; 725/131; 725/46

(57) ABSTRACT

The present invention provides techniques for accessing multi media information. Specific embodiments include systems, apparatuses, methods, and software that provide access to information from disparate resources. The present invention provides a web tuner system that provides access to multiple kinds of media through a single interface in an exemplary embodiment. The web tuner system comprises equipment which can be located at a home, home office or small business office. The equipment provides a panel that displays media information, and a remote control with which the user may select media to receive. The user may also input information about various kinds of media of interest. The web tuner receives multiple types of media, such as television, radio broadcast, and Internet based information, such as from the world wide web. The information is output into external equipment of various types, such as television, for example. Accordingly, the web tuner provides a media type independent interface and control for receiving information, so that the user is able to operate a single interface to receive multiple types of media.

### CROSS-REFERENCES TO RELATED APPLICATIONS

The following commonly-owned co-pending applications, including this one, are being filed concurrently and the others are hereby incorporated by reference in their entirety for all purposes:

1. U.S. patent application Ser. No. ______, Yuichi Taguchi and Kenji Takeda, entitled, “Global Multi Media Service Method and Apparatus,” (Attorney Docket Number 37016-00181/HAL-ID-151A) and

2. U.S. patent application Ser. No. ______, Yuichi Taguchi and Kenji Takeda, entitled, “Global Multi Media Service System and Apparatus,” (Attorney Docket Number 37016-00184/HAL-ID-151B).

### BACKGROUND OF THE INVENTION

The present invention relates generally to techniques for accessing multi media information, and in particular to techniques for accessing multi media information from disparate resources.

Today, media is delivered to the home, small office and home office in a variety of formats. These formats include not only traditional media delivery formats such as television and radio, but also the so-called “new economy” information channels, such as the World Wide Web (WWW) and other Internet information resources. As these media information channels developed independently of one another, at different times, and by different promoters, the audience requires a variety of disparate equipment in order to receive the different types of information. For example, the audience may own items such as a TV set, a radio, an amplifier, a speaker, a PC or a PDA, some cables, and so forth. Accordingly, the audience must perform disparate operations in order to receive the information using these different media delivery mechanisms. For example, the audience must operate a TV remote control in order to receive television broadcasts, tune a radio tuner to receive AM/FM radio broadcasts, and use a keyboard and a mouse to access information on the web. But are all these different devices and operating modes really necessary?

Internet information resources are frequently accessed using Internet portal sites, such as, Yahoo!™, Excite™, Netscape™ and so forth. These Internet portal sites have become popular and useful tools that assist viewers of Internet based media with finding and accessing web resources according to categories or by using a search engine. The viewer refers to the Internet portal in order to select information of interest for receiving. The information can be forwarded to the viewer by the Internet portal. These portal sites also provide access by using a search engine. The search engine enables the viewer to search web resources for desired contents.

Alias services, such as Netscape's web site (http://www.netscape.com) enable users to access a particular web resource using a hyperlink located on the web site. For example, if a user selects a hyperlink associated with the NY Times™, the user's access request is forwarded to an appropriate web site, such as http://www.nytimes.com, in this instance. Such alias services enable users to access popular web information resources from a single web site. This approach saves the user from keeping track of the URL of the target web site.

Viewers of web content typically operate a keyboard and mouse devices to access the information. One exception is Web TV™. Web TV (http://www.webtv.net) is another popular Internet access method in use today. WebTV users view web content using an ordinary television. The television provides the user with the functionality of a web browser, which can be accessed using an ordinary television, bringing the web into the user's own living room. The WebTV interface may be operated without using a traditional keyboard and mouse device, such as those found on a PC. Rather, the Web TV interface provides browser-based “point and click” functionality to users using the television set.

While certain advantages to such conventional approaches are perceived, opportunities for further improvement exist. One problem faced by conventional interfaces to Internet resources is that web resources are changing virtually constantly. Conventional approaches that use a “bookmark” feature of the browser program, or require the user to input the URL directly, require that the user track the location of the web resource if it changes. Furthermore, the “bookmarks” are specific to the machine in which the bookmark is established. Thus, users who access web information from a machine other than their own, frequently have difficulty locating favorite sites. Users, may find it inconvenient to copy bookmark data into another machine in order to refer to bookmarks at a remotely located place. Accordingly, viewers must often search for the web content of interest using a portal site, or a search engine, when the user desires access to the web information.

Further, little commonality exists among user interfaces for the various mechanisms for accessing information content of interest to users. PC users interface with the web browser using a keyboard and a mouse. The WebTV interface works without a keyboard and mouse. Search engines typically require the user to enter a search string, or a natural language text for searching. Alias sites, such as Netscape, and portal sites provide tracking of web resources to the user that does not mind the additional level of indirection involved in going first to the portal or alias site.

What is needed are improved techniques for accessing multi media information from disparate resources.

### SUMMARY OF THE INVENTION

The present invention provides techniques for accessing multi media information. Specific embodiments include systems, apparatuses, methods, and software that provide access to information from disparate resources. In an exemplary embodiment, the present invention provides a web tuner system that provides access to multiple kinds of media through a single interface. The web tuner system comprises equipment which can be located at a home, home office or small business office. The equipment provides a panel that displays media information, and a remote control with which the user may select media to receive. The user may also input information about various kinds of media of interest. The web tuner receives multiple types of media, such as television, radio broadcast, and Internet based information, such as from the world wide web. The information is output to external equipment of various types, such as a television, video monitor, or the like. Accordingly, the web tuner provides a media type independent interface and control for receiving information, so that the user is able to operate a single interface to receive multiple types of media.

Furthermore, in specific embodiments, the present invention provides a web tuner having a channel service interface for multiple types of media. The web tuner system assigns media information resources into logical channel values. The user selects media by selecting a channel, which is translated into a real media source by the web tuner. Logical channel values can be attached to sources of media that can be received by users. For example, a broadcast by NBC receivable on TV channel 4 may be mapped into a logical channel “1”, a radio broadcast by KBAY on a radio frequency 94.5 MHz may be mapped into a logical channel “112”, and a web site, such as Yahoo!, having a URL of http://www.vahoo.com/, may be mapped into a logical channel “1011.” These logical channels are managed in a single table in the web tuner and are selectable by a common interface mentioned above. Accordingly, in specific embodiments, users are able to receive media from multiple sources using a channel logic, as if the user were operating a television.

In a specific embodiment, the present invention provides a web tuner system comprising a “web station” component. The web station is interfaced with the Internet and is accessible by a URL. The web station provides various services to the web tuner. The web station enables the web tuner users, i.e., the audience, to reduce content search operations, and bookmark maintenance. In a specific embodiment, the web station comprises a subscriber URL database that categorizes media content into hierarchical categories, as well as into relational categories. One example categorization paradigm used in a specific embodiment, comprises categories such as [Home]-[Business and Economy]-[Trade], or [Home]-[Computers and Internet]-[Multimedia]-[Audio]. Accordingly, hyperlink information, and relational database identifiers, may be associated with media content by the web station subscriber URL database. The user who views the media is able to access media having desired content, as well as media having related content more easily. The content categorization may be performed using the single interface provided by the web tuner in specific embodiments.

Specific embodiments enable users to customize a logical channel table of the web tuner. In these embodiments, a personalized channel table provides bookmark information for multiple types of media. The personal channel table of the web tuner is mirrored in the web station database, enabling users to reference the channel table from remote locations by accessing the web station. Accordingly, in these embodiments, users are able to access a personal media environment from disparate locations.

In another specific embodiment, the present invention provides a web tuner apparatus comprising a variety of components. The apparatus includes a first means for storing at least one of a plurality of relationships between a user definable identifier for a media source and a source of a media stream; a means for remotely controlling receiving, and selecting media, and for receiving an input of the one or more relationships between a user definable identifier and a media source; a means for displaying information about media sources and receiving input of a selection of a media stream to be played; a means for selecting one of the one or more types of media to receive based upon the input of a selection of a media stream to be played; a means for receiving one or more types of media; and an output interface means for providing a media output selected by the means for selecting.

In a further specific embodiment, the present invention provides a web station apparatus comprising a means for storing subscriber URL information. The information comprises one or more hierarchical categories. The categories provide organization for identifiers of media content for one or more sources of media streams. The apparatus further comprises a network interface means for providing connectivity to an Internet; a means for searching the hierarchical categories in the subscriber URL information to find media having content of interest; and a means for providing the content of interest to a user. The network interface enables the web station apparatus to be accessible by a web tuner apparatus. The media is accessible by commanding the web station to search the hierarchical categories in the subscriber URL information store, in order to find media having content of interest. The content categorization performed using an interface provided by the web tuner.

In a further specific embodiment, the present invention provides a system comprising a web station; a web tuner; and a network interface. The network interface provides connectivity to an Internet and enables the web station to be accessed by the tuner. The web tuner maintains personal channel information for one or more users. The web station maintains a copy of the personal channel information for one or more users.

In a yet further specific embodiment, the present invention provides a computer readable storage medium storing program code. The program code causes a computer to retrieve one or more of identifiers for a media source of media streams to be played. The media sources may be of disparate types, such as cable television, television broadcast, radio broadcast, world wide web, and Internet based information, for example. Displaying one or more of identifiers for a media source of media streams to be played so that a user may select a media stream to be played from one or more of media to receive using a user interface, for example is also performed by the computer under control of the program code. The user selects one from the one or more of identifiers for a media source of media streams to be played. The program code also causes the computer to command a switch to select the media stream to be played from among the one or more of types of media received by at least one receiver and output the media stream to be played via an output interface.

In specific embodiments, the identifiers comprise user definable identifiers that are stored in a first personal information store. The program code further causes the computer to forward, from a first location, a copy of the first personal information store to a server. A copy of the first personal information store is created at the server, and the copy of the first personal information store is accessed in order to retrieve the one or more of user definable identifiers for a media source of media streams to be played from a second location at a later time.

In specific embodiments, the program code further causes the computer to store a user definable identifier for a media source of a media stream being played currently. The user definable identifier is stored in the first personal information store.

In specific embodiments, the identifiers are stored in a subscriber URL information store. The program code further causes the computer to store an identifier for a media source in a subscriber URL information store. The subscriber URL information store comprises one or more hierarchical categories. The categories provide organization for identifiers of media content.

In specific embodiments, the program code further causes the computer to select, via a user interface, a related media stream to be played. The related media stream to be played has content related to the media stream to be played. The selecting comprises selecting one from one or more of URL identifiers for the media stream to be played, and thereupon selecting a second URL identifier corresponding to the related media stream to be played.

In specific embodiments, the program code further causes the computer to receive an identity of a user and providing a plurality of user definable identifiers for the user. The plurality of user definable identifiers for the user comprises a table of channel information for the user's media of interest.

In specific embodiments, the program code further causes the computer to scan an input source for one or more of receivable television channels and map the one or more of receivable television channels to one or more of identifiers. The program code also causes the computer to scan an input source for one or more of receivable radio frequencies and map the one or more of receivable radio frequencies to one or more of identifiers. Further, the program code causes the computer to scan an input source for one or more of internet based media sources and map the one or more of internet based media sources to one or more of identifiers.

Numerous benefits are achieved by way of the present invention over conventional techniques. Specific embodiments according to the present invention provide a global media service system, methods, apparatuses, and computer software to control multiple heterogeneous types of media using a single channel model. In specific embodiments, users are able to operate web and other media more easily than with conventional approaches. For example, in a specific embodiment, users input a logical channel “1” in order to receive “channel 51” of TV media, and a logical channel “101” to receive radio programs, a logical channel “1001” to receive http://www.news.com/news, and so forth. This numerical channel paradigm is only one of a variety of different ways that channels may be identified in various specific embodiments according to the present invention. In other specific embodiments, alphanumeric characters and character strings, icons, colors, and the like may be used to identify channels to the user.

Users can refer to their own logical channel information from a remote location. The user can refer to personalized logical channel information from virtually anywhere that the user has access to a web station. For instance, if a user customizes his or her own logical channel as a “favorite bookmark”, then the user can use the logical channel in a hotel from which the web station may be accessed.

The present invention provides navigation directed web browsing in various specific embodiments. Related content sources are displayed on a channel display device while a user browses a web resource. Accordingly, users can refer to content that is associated with current content. For example, while a user is browsing movie information on the web, an “actor's profile” site and a “making history” site can be introduced on a channel display device in a specific embodiment. The user can access these sites with a mere single click operation.

These and other benefits are described throughout the present specification. A further understanding of the nature and advantages of the invention herein may be realized by reference to the remaining portions of the specification and the attached drawings.

### BRIEF DESCRIPTION OF THE DRAWINGS

FIG. 1 illustrates an overview of a representative system for embodying the present invention.

FIG. 2 illustrates a hardware diagram of a representative web station in a specific embodiment according to the present invention.

FIG. 3 illustrates a software diagram of a representative web station in a specific embodiment according to the present invention.

FIG. 4 illustrates an example entry in a representative personal information database in a specific embodiment according to the present invention.

FIG. 5 illustrates a diagram of a representative arrangement for a subscriber URL information database in a specific embodiment according to the present invention.

FIG. 6 illustrates a hardware diagram of a representative web tuner in a specific embodiment according to the present invention.

FIG. 7 illustrates a software diagram for a representative web tuner in a specific embodiment according to the present invention.

FIG. 8 illustrates a representative media control device in a specific embodiment according to the present invention.

FIG. 9 illustrates an example of a channel table in a specific embodiment according to the present invention.

FIG. 10 illustrates an example image from a representative channel output device in a specific embodiment according to the present invention.

FIG. 11 illustrates an example channel select interface in a specific embodiment according to the present invention.

FIG. 12 illustrates a representative channel customize interface in a specific embodiment according to the present invention.

FIG. 13 illustrates a representative user customize interface in a specific embodiment according to the present invention.

FIG. 14 illustrates a flowchart of representative processing performed by a web station in a specific embodiment according to the present invention.

FIG. 15 illustrates a flowchart of representative processing performed by a web tuner in a specific embodiment according to the present invention.

FIG. 16 illustrates a flowchart of representative processing performed by a web server in a web station in a specific embodiment according to the present invention.

FIG. 17 illustrates a flowchart of representative processing performed by a personal information management program in a specific embodiment according to the present invention.

FIG. 18 illustrates a flowchart of representative processing performed by a URL information management program in a specific embodiment according to the present invention.

FIG. 19 illustrates a flowchart of representative processing performed by a URL information delivery program in a specific embodiment according to the present invention.

FIG. 20 illustrates a flowchart of representative processing performed by a main controller program in a web tuner in a specific embodiment according to the present invention.

FIG. 21 illustrates a flowchart of representative processing performed by a media selector program in a web tuner in a specific embodiment according to the present invention.

FIG. 22 illustrates a flowchart of representative processing performed by a channel customize program in a specific embodiment according to the present invention.

FIG. 23 illustrates a flowchart of representative processing performed by a channel mapping program in a specific embodiment according to the present invention.

### DESCRIPTION OF THE SPECIFIC EMBODIMENTS

The present invention provides techniques for accessing multi media information. Specific embodiments include systems, apparatuses, methods, and software that provide access to information from disparate resources.

There are various kind of media delivered to the home, small office, and home office today. Media is distributed in a variety of formats, such as web pages, television broadcasts, cable television, and radio broadcasts. The web information is distributed by internet, television programming comes by cable, satellite broadcasts, and point to point surface broadcasts, and radio by point to point surface broadcasts. Conventionally, each of these media types requires a specific type of reception device in order to receive it. Thus, heretofore, the user needed a TV set to receive television broadcasts, a radio receiver to receive the radio broadcasts, and so forth. Conventionally, a PC and some kind of modem and a monitor are needed to receive web content. By contrast, embodiments according to the present invention provide a unitary mechanism for receiving a variety of disparate media.

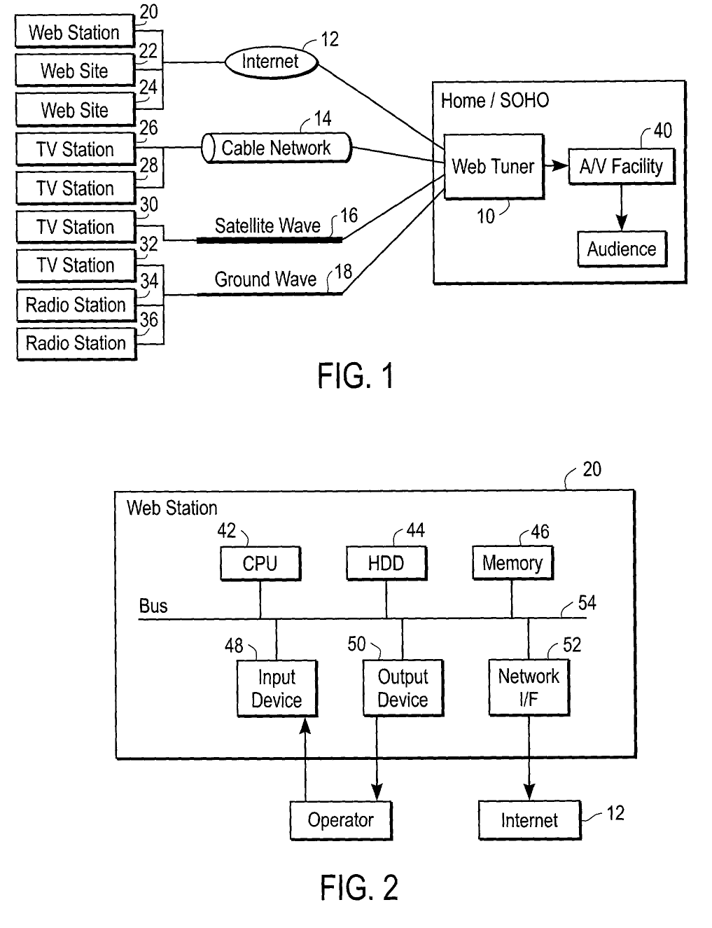

FIG. 1 illustrates an overview of a representative system for embodying the present invention. As illustrated by FIG. 1, a web tuner 10 is typically resident within a home, small office, or home office, for example. The web tuner 10 comprises a plurality of interfaces that enable the web tuner 10 to be connected to media sources of a variety of types. Interfaces provide access to Internet 12, a cable television network 14, a satellite broadcast reception link 16, and a surface reception link 18, for example. Internet 12 provides media from a variety of sources, such as web sites 22 and 24, as well as ftp sites (not shown), email servers (not shown), and the like. Cable television network 14 provides media from cable television stations 26 and 28. Satellite broadcast reception link 16 provides media from TV stations 30 and 32. Surface reception link 18 provides media from radio stations 34 and 36. The web tuner 10 receives various types of media from these connections and outputs a specific media stream selected from the various media connections into Audio or visual signal (AN) capable reception equipment in the home, small office or home office, such as AN facility 40. The AN facility 40 may be a television, video monitor, or the like.

FIG. 1 further illustrates a web station 20 connectable to the web tuner 10 via the Internet 12. The web station 20 provides media navigation services to the web tuner 10. These media navigations services are described in detail herein below.

FIG. 2 illustrates a hardware diagram of a representative web station in a specific embodiment according to the present invention. The web station 20 may be embodied using PC hardware, the components of which are readily familiar to those skilled in the art, and therefore will be described herein briefly. In FIG. 2, web station 20 comprises a CPU 42, a persistent storage 44, which can be a hard disk drive (HDD), a memory 46, one or more input devices 48, which can be a keyboard, a mouse, or both, an output device 50, which can be a video monitor, for example, and a network interface 52 for providing connection to Internet 12 for example. A bus 54 provides connection between these various components. In specific embodiments, web station 20 may comprise other and different types of devices than those illustrated by FIG. 2. For example, web station 20 may comprise a CD ROM drive unit, a removable disk storage drive unit, a tape backup unit, or the like. Further, in some specific embodiments, not all components of web station 20 illustrated by FIG. 2 may be present, or different components may be substituted. For example, in specific embodiments, input device 48 may comprise a scanner, a touch pad, a touch screen, a track ball, a joy stick, a video camera, an audio microphone and the like. Accordingly, the web station 20 illustrated by FIG. 2 is intended to be illustrative and not limiting.

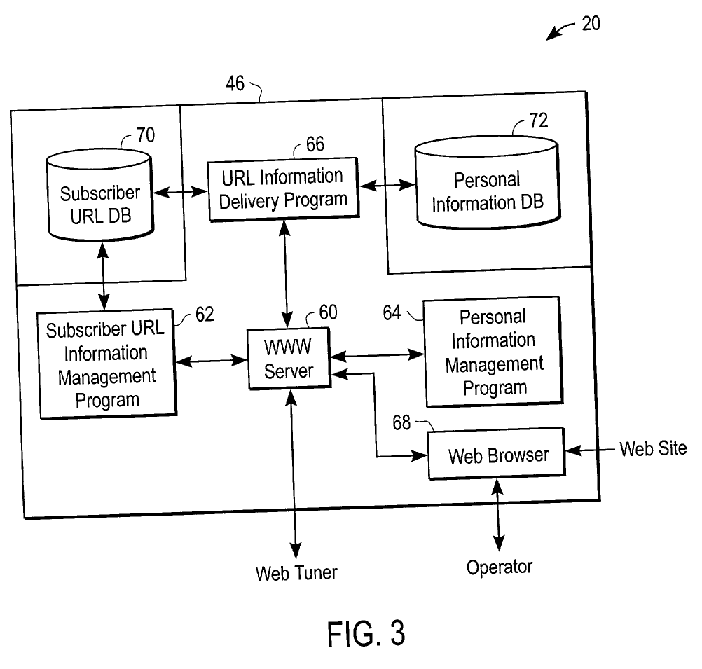

FIG. 3 illustrates a software diagram of a representative web station in a specific embodiment according to the present invention. As shown in FIG. 1, web station 20 communicates with the web tuner 10. A world wide web server 60, is a resident process within the memory 46 of the web station 20. Web server 60 provides an interface between web tuner 10 and the other processes resident in the web station 20. Communications traffic between web station 20 and web tuner 10 can be in accordance with an Hyper Text Transfer Protocol (HTTP), for example. In a specific embodiment, the web server 60 is capable of receiving HTTP requests from the web tuner 10 via Internet 12. The HTTP protocol provides for requests such as PUT and GET for transferring information between two or more computers on the Internet. For a detailed description of the HTTP protocol version 1.1, reference may be had to Network Working Group, RFC 2616, (ftp://ftp.isi.edu/in-notes/rfc2616.txt, last accessed Feb. 7, 2001), the entire contents of which are incorporated herein by reference for all purposes.

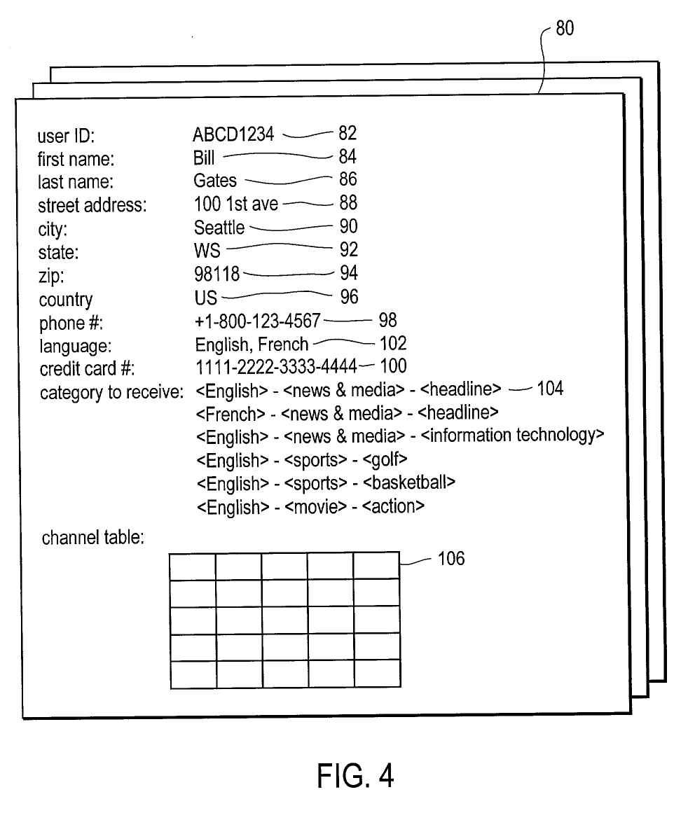

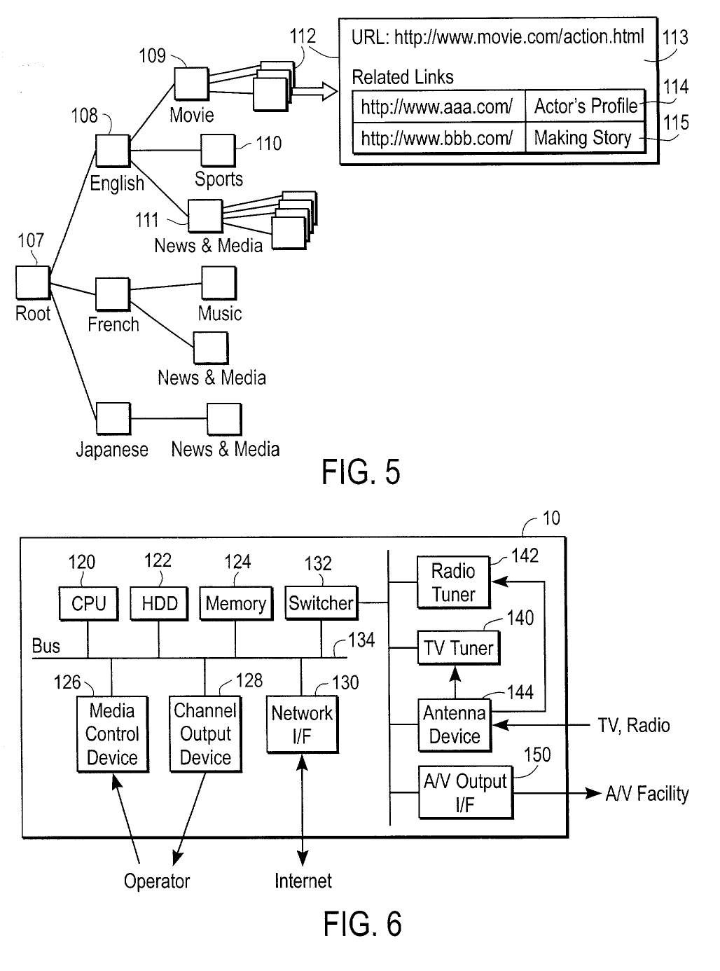

A subscriber URL database 70 stores information about web based media sources, such as the URL of a media source, one or more categories in which the content of the media from the source may be classified, and relationships between the content from different media sources. In a specific embodiment, the subscriber URL database 70 is resident on the hard disk drive 44 of the web station 20. The subscriber URL database 70 stores URL information for media sources using hierarchical categories and relational information in a presently preferred embodiment. The organization of an example subscriber URL database 70 will be described in further detail with reference to FIG. 5 herein below. A personal information database 72 stores personal information, such as a name, an address, a language of choice, a credit account, and favorite content categories for individual users. Each user's information is used for accounting, as well as to provide personalized web resource information. This is described with reference to FIG. 4 herein below.

A subscriber URL information management program 62 manages the subscriber information in the subscriber URL database 70. If HTTP PUT/GET requests received by web server 60 include subscriber URL information updates, then the subscriber URL information management program 62 searches the subscriber URL database 70 for the information classified in the requested categories. If found, the information may be updated according to the request. Otherwise, a new entry for one or more specified categories may be created. Then, the URL information management program 62 translates a result code indicating the status of this processing into a reply message in HTTP format and forwards the reply message to web server 60.

A personal information management program 64 manages the personal information in the personal information database 72. The web tuner 10 users maintain their own personal information stored in personal information database 72. When the web server 60 receives update/reference requests, the web server 60 dispatches processing of these requests in the personal information management program 64. Personal information management program 64 writes and reads requested information stored in personal information database 72 according to the request. Then, the personal information management program 64 translates a result code indicating the status of this processing into a reply message in HTTP format and forwards the reply message to web server 60.

A URL information delivery program 66 searches for requested information, either URL or URL category, and replies with the URL information if found. When the web tuner 10 users request to receive URL categories or URL information, this program receives the request from the web server 60. If the user's request is for URL information, then this program searches the subscriber URL information database 70. If personalized alias information is requested, this program searches the personal information database 72 for category information corresponding to the personalized alias in the request. Then, this program searches the subscriber URL information database 70 for URL information based upon the category information retrieved from the personal information database 72. Once information responsive to the request has been retrieved, then the URL information delivery program 66 generates a reply message with the retrieved URLs, and forward the message to the web server 60. The web station 20 employs configuration tools of the database management interface in order to manage the databases. These configuration tools may be incorporated with a web browser 68 in specific embodiments. In a specific embodiment, the subscriber URL information management program 62 and the personal information management program 64 employ graphical user interfaces (GUI) that employ hypertext markup language (HTML) to produce and display GUI interface screens. The GUI interface screens are displayed by the web browser 68, which also accepts operation commands.

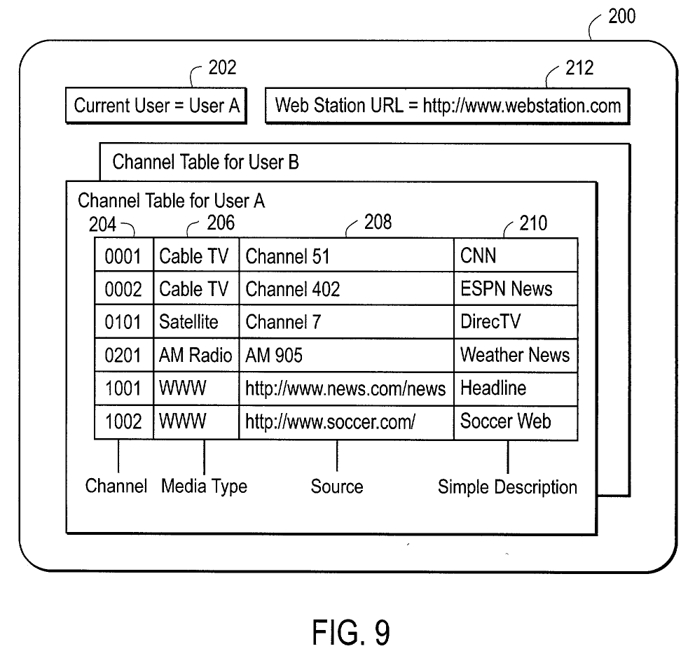

FIG. 4 illustrates an example entry in a representative personal information database in a specific embodiment according to the present invention. For accounting purposes, the service provider owner of the web station 20 obtains information about users. This information is stored in the personal information database 72 of web station 20. The example entry 80 illustrated by FIG. 4 comprises a user ID 82, a first name 84, a last name 86, a street address 88, a city 90, a state 92, a zip code 94, a country 96, a telephone number 98, and a credit card number 100 that are managed in the personal information database 72. Entries in the personal information database 72 also include user specific media information. A language field 102 in entry 80 indicates a suitable language with which the user reads and listens to media. A category to receive field 104 is used to store some of the categories that are classified in subscriber URL database 70. The web tuner 10 user registers the categories, so that the web station 20 is able to provide adaptive URLs that are classified into appropriate categories and are stored in the subscriber URL database 70. A channel table field 106 in entry 80 comprises a personalized logical channel table maintained by the web tuner 10 user. The web station 20 uses this information to map logical channel values inputted by the user into actual sources of media information. The logical channel table in a user's personal information is synchronized with a corresponding logical channel table stored in the web tuner 10. This table is described herein below with reference to FIG. 9.

FIG. 5 illustrates a diagram of a representative organization for a subscriber URL information database in a specific embodiment according to the present invention. In the example organization of FIG. 5, URL information in subscriber URL database 70 is categorized into categories hierarchically. For example, categories such as movie 109, sports 110, and news 111 are child categories of a parent category, English 108. Further, the category English 108 is a child of a root category 107. The root category has other children as well. Yet further, each categorized URL comprises hyperlink information. For example, a particular movie entry 112 corresponds to a URL for a movie site, (http://www.movie.com/action.html) 113. Further, movie entry 112 comprises a plurality of related links, including a link to an actor's profile site, (http://www.aaa.com/) 114, and a link to a making story site (http://www.bbb.com/) 115. Accordingly, link information that is associated with the URL information within the web station 20 enables users to access other media content. There are a variety of categories that can be included in the subscriber URL database 70, as well as many different ways that these categories can be organized in specific embodiments of the present invention. Accordingly, the example depicted in FIG. 5 is intended to be merely illustrative and not limiting of the many specific embodiments of the present invention.

FIG. 6 illustrates a hardware diagram of a representative web tuner in a specific embodiment according to the present invention. In a specific embodiment, the web tuner 10 of FIG. 6 may be embodied using PC hardware, the components of which are readily familiar to those skilled in the art, and therefore will be described herein briefly. FIG. 6 shows web tuner 10, which comprises a CPU 120, a persistent storage 122, which can be a hard disk drive (HDD), a memory 124, a media control device 126, a channel output device 128, a network interface 130 for providing connection to Internet 12 for example, and a switcher device 132, for selectively coupling any of a plurality of media inputs to an A/V output interface 150. A bus 134 provides connection between the various components of web tuner 10.

Switcher device 132 operates under control of program software stored in memory 124 and executed by the CPU 120. The switcher device 132 provides a mechanism for selecting a media stream for output to the A/V output interface 150. The media stream may be selected from any of a plurality of media input devices, including a television tuner 140 that selects a frequency from among television broadcast media, and a radio tuner 142 that selects a frequency from among radio broadcast media. An antenna device 144 receives point to point surface broadcasts for television and radio format media. The A/V output interface 150 provides RGB format video and audio output signals, for example, to an A/V facility (not shown), such as a television or monitor.

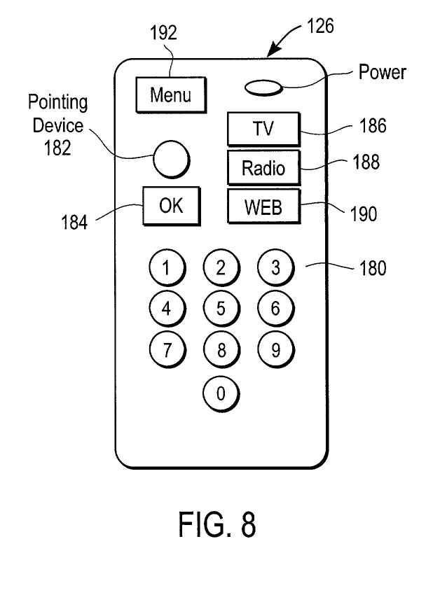

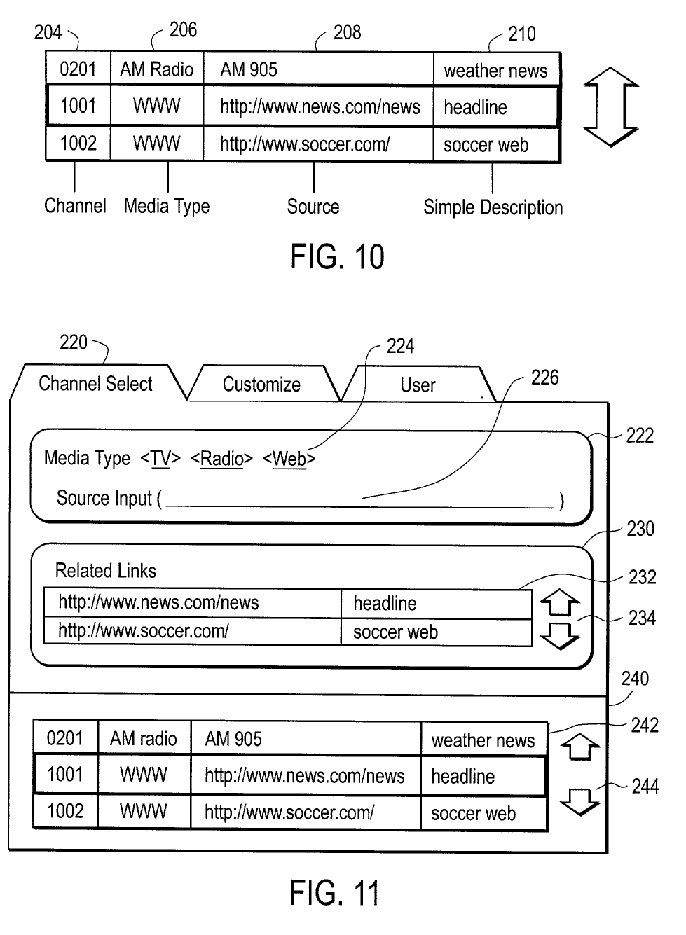

The media control device 126 and the channel output device 128 of the web tuner 10 comprise a user interface for the user. The media control device 126 provides a common interface for operating multiple media. Using the media control device 126, the user can select a particular media stream to be received according to channel input. The media control device 126 comprises a user interface, which is described in detail herein below with reference to FIG. 8. The channel output device 128 comprises a display that shows a current status for media streams. The channel output device and display format are described herein below with reference to FIG. 10.

In specific embodiments, web tuner 10 may comprise other and different types of devices than those illustrated by FIG. 6. For example, web tuner 10 may comprise a CD ROM drive unit, a removable disk storage drive unit, a tape backup unit, or the like. Further, in some specific embodiments, not all components of web tuner 10 illustrated by FIG. 6 may be present, or different components may be substituted. For example, in specific embodiments, input devices such as a scanner, a touch pad, a touch screen, a track ball, a joy stick, a video camera, an audio microphone and the like may provide inputs to web tuner 10. Accordingly, the web tuner 10 illustrated by FIG. 6 is intended to be illustrative and not limiting.

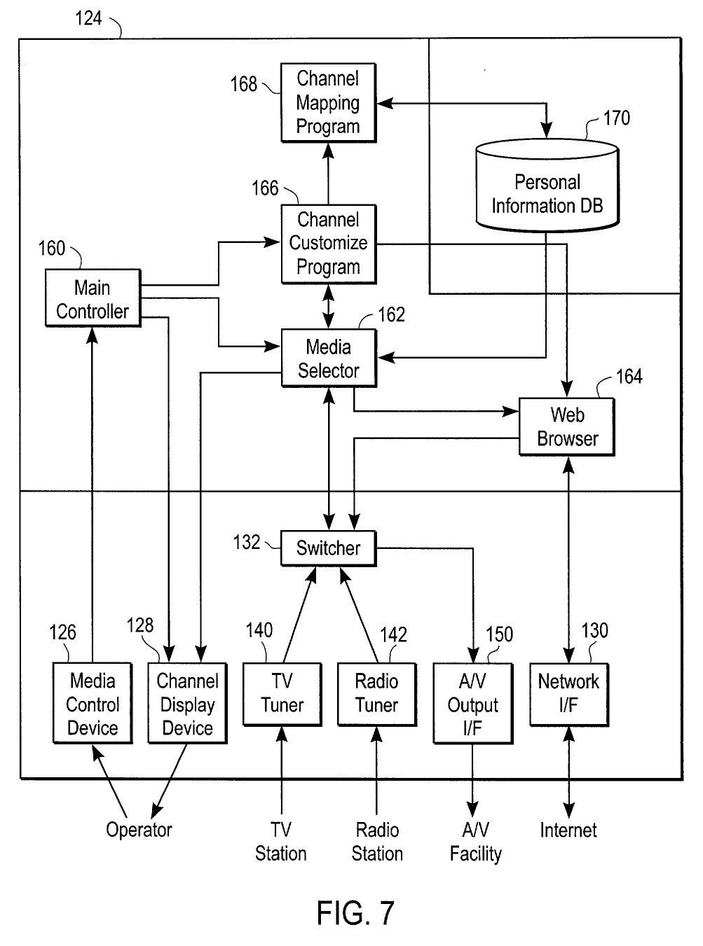

FIG. 7 illustrates a software diagram for a representative web tuner in a specific embodiment according to the present invention. In FIG. 7, a plurality of program processes that reside in memory 124 of the web tuner 10 are illustrated along with their relationships to the hardware components of the web tuner 10, shown at the bottom part of FIG. 7. FIG. 7 illustrates a main controller program 160 that dispatches various requests from the user received by the media control device 126. The requests that the web tuner 10 receives from users include a channel customize request, a media select request, and a personal information customize request. If the request is a channel customize request, then the main controller 160 executes a channel customize program 166 and commands a media selector program 162 to display a personal channel table on the A/V facility (not shown), which is described herein below with reference to FIG. 9. If the request is a media select request, then the main controller program 160 commands the media selector program 162 to receive requested media. If the request is a personal information customize request, then the main controller program 160 commands the channel customize program 166 to process the request. These processes are described herein below.

The media selector program 162 controls the switching of the media stream to be received from among the possible media sources by operating the switcher device 132. Further, the media selector program 162 invokes a web browser program 164. The web browser program 164 provides an interface for the user. The web browser program 164 provides communications between the web tuner 10 and the web station 20 through the Internet 12. The switcher device 132 enables the A/V output I/F 150 to display a user interface screen provided by the web browser program 164 onto the A/V facility (not shown). The web browser program 164 displays a mouse pointer to provide the user a way to select items on the web browser screen displayed at the A/V facility by the A/V output I/F 150.

The channel customize program 166 manages the user's personalized channel information. The web tuner 10 users maintain their own channel tables which are stored in a personal channel information database 170. In a specific embodiment, the personal channel information database 170 is resident on hard disk drive 122 of the web tuner 10. The personal channel table is described herein below with reference to FIG. 9. The channel mapping program 168 maps logical channel values into real media information using the content of the personal channel information database 170. For example, in a scenario in which a logical channel value of “4” is requested by a user, the channel customize program 166 refers to a personal channel table for the user stored in the personal channel information database 170, and returns a real media resource, such as “http://www.yahoo.com.” The user stored this mapping between the channel value “4” and the site “http://www.yahoo.com” in the table previously.

FIG. 8 illustrates a representative media control device in a specific embodiment according to the present invention. FIG. 8 illustrates an example media control device 126 that is used to control reception of television broadcast, radio broadcast and web based media. The media control device 126 comprises a keypad 180 which receives input from the user such as logical channels and alphanumeric input. A pointing device 182 and an “OK” button 184 control a mouse pointer displayed on the video media provided as A/V output from the A/V output I/F 150 of the web tuner 10. One or more special purpose buttons are also provided. For example, a TV button 186, a radio button 188, and a web button 190 provide “one-touch” capability to change the media received. A menu button 192 provides the user with the capability to quickly bring up a menu for display.

FIG. 9 illustrates an example of a channel table in a specific embodiment according to the present invention. In FIG. 9, a channel table 200 is populated with information for a particular user which is stored in the personal channel information database 170. This database includes channel tables for one or more users. A current user field 202 indicates the identity of the current user operating the web tuner 10. The channel table 200 comprises a channel field 204, a media type field 206, a source field 208, and a simple description field 210. The channel field 204 is a logical channel which is assigned to a source of a media stream by the channel mapping program 168. The media type field 206 holds a real media type. The source field 208 is the media source. This field holds a channel value when the media type is TV, a frequency when the media type is radio, or a URL when the media type is WWW. The simple description field 210 is an optional field. Information from these fields is displayed on the media output device 128 to the user. Additionally, to mirror the contents of the personal channel information database 170 of the web tuner 10 to the personal information database 72 of the web station 20, a web station URL field 212 is stored along with these other fields.

FIG. 10 illustrates an example image from a representative channel output device in a specific embodiment according to the present invention. The channel output device 128 comprises a display panel that provides information about the media being received to the user. In FIG. 10, a representative example of some information from the channel table 200 of FIG. 9 is displayed by the channel output device 128. The content displayed by the channel output device 128 comprises the channel field 204, the media type field 206, the source field 208, and the simple description field 210. The user can scroll through the channel table displayed on the channel output device 128 and select media with the channel input device 126. A media stream from the selected media source will then be provided to the A/V output I/F 150.

FIG. 11 illustrates an example channel select interface in a specific embodiment according to the present invention. A variety of interfaces are provided by the web tuner 10 to assist the user in customizing the personal logical channel table 200 and in selecting a media source from the channel table. The user interface is displayed using the web browser 164 by the A/V facility connected by the A/V output interface 150. FIG. 11 shows a channel select interface 220 that enables users to select a media source from which to receive media. A top portion 222 of the channel select interface 220 is used to manually input a source designation for media to be received. The user can receive media by selecting a media type 224, and providing input of source information into a source information input field 226. Source information includes information such as “channel 4”, “88.5 MHz”, or “http://www.yahoo.com”.

A middle portion 230 of the channel select interface 220 shows related links information 232. As shown above in FIG. 5, content may have one or more related links information associated with the source information of the content. The web station 20 provides this information responsive to a user's request, and the web tuner 10 displays the information on this portion of the interface. The example of FIG. 11 shows related links information 232 comprising a hyperlink URL, http://www.news.com/news, and a short description, “headline,” displayed in the middle portion 230. The user clicks these links to receive content from these media sources. The user may also click on scroll icons 234 to scroll the related links information 232.

A bottom portion 240 of the channel select interface 220 shows a portion 242 of the logical channel table 200 illustrated in FIG. 10. This provides the user a display of channel selection information for selecting media to receive from the media sources in the channel table 200. The user can click a portion of the displayed logical channel table 200 to receive media from the associated source or use the scroll icons 244 to scroll the channel table portion 242.

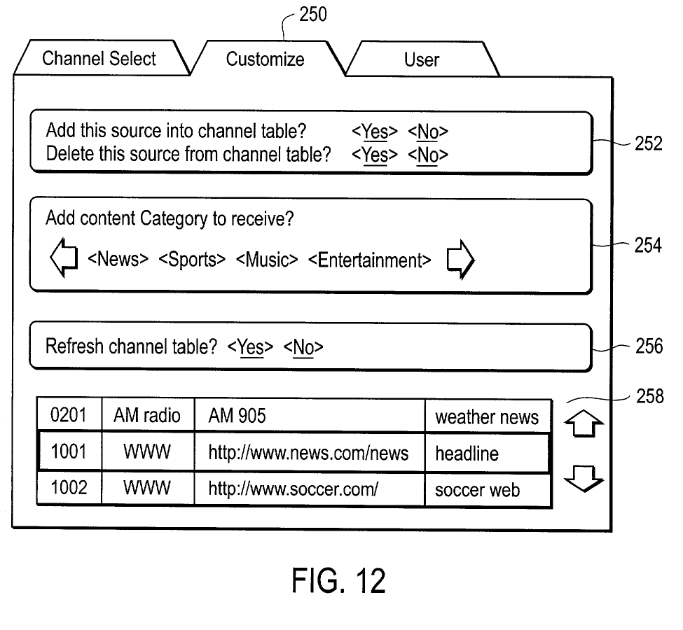

FIG. 12 illustrates a representative channel customize interface in a specific embodiment according to the present invention. FIG. 12 shows a channel customize interface 250 of web tuner 10, which enables users to customize the logical channel table 200. The channel customize interface 250 enables users to personalize the selection of channels with the user's favorites. A first portion 252 of the channel customize interface 250 provides functions to add to or delete from the logical channel table 200 a media source from which media is currently being received. A second portion 254 of the channel customize interface 250 provides the capability to customize a “favorite category” stored in the web station 20. As shown in FIG. 4, the web station 20 stores a user's favorite categories and URLs classified into the favorite categories. The second portion 254 of the channel customize interface 250 is used to request that a category be added to or deleted from the personal information 106 stored in the web station 20. A third portion 256 of the channel customize interface 250 is used to refresh the channel table 200. As a result of user's customization, the logical channels in the logical channel table 200 are changed. The third portion can be used to trigger a refresh to the logical channel table 200. Refresh is an optional function that applies user changes to a portion 258 of the logical channel table. A fourth portion 258 of the channel customize interface 250 displays a portion 258 of the logical channel table shown in FIG. 10. This enables the user to view the result of the customization.

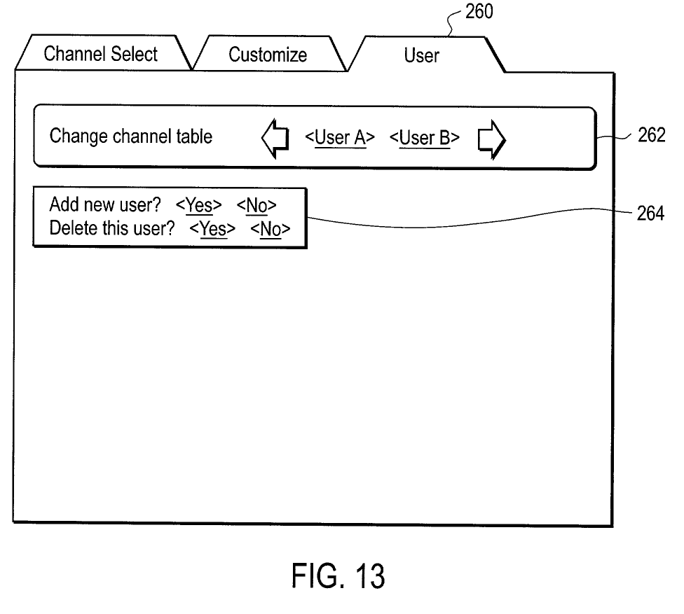

FIG. 13 illustrates a representative user customize interface in a specific embodiment according to the present invention. As described above with reference to FIG. 9, the web tuner 10 can keep logical channel tables for multiple users. FIG. 13 shows a user customize interface 260 of web tuner 10, which enables users to add to and delete from the logical channel tables 200 of the web tuner 10. A first portion 262 of the user customize interface 260 provides the capability to switch a “current” user. A second portion 264 of the user customize interface 260 provides the capability to create a user in the logical channel table 200, or to delete a user from the logical channel table 200.

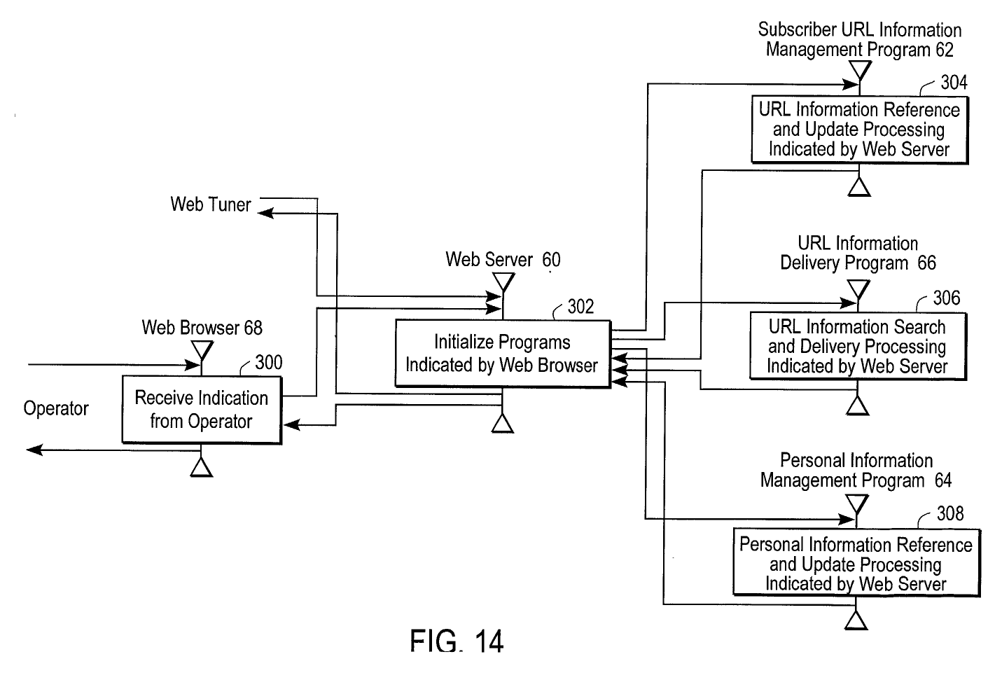

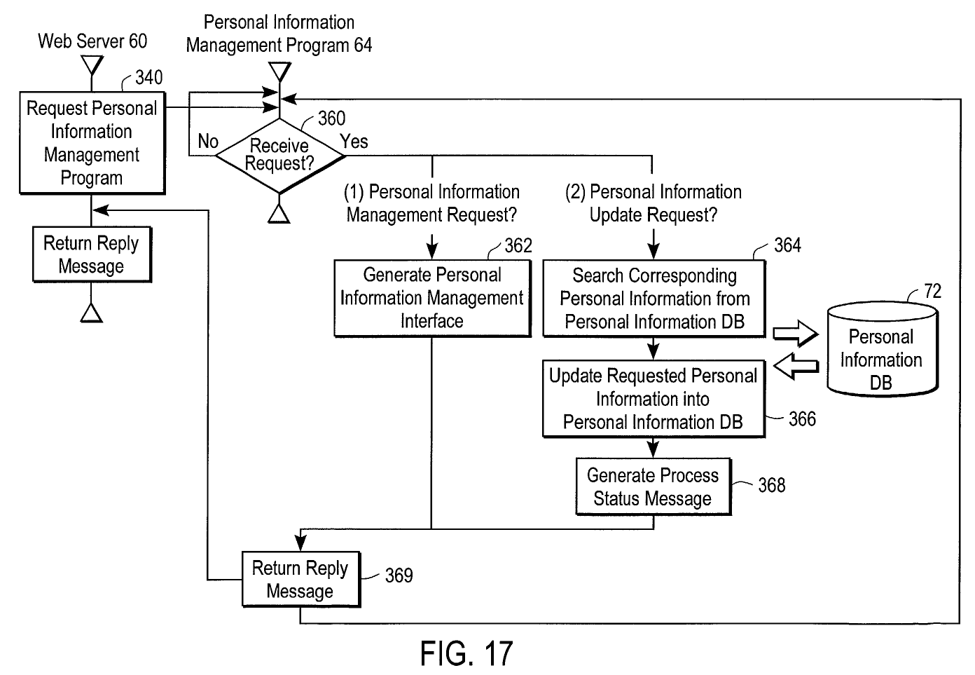

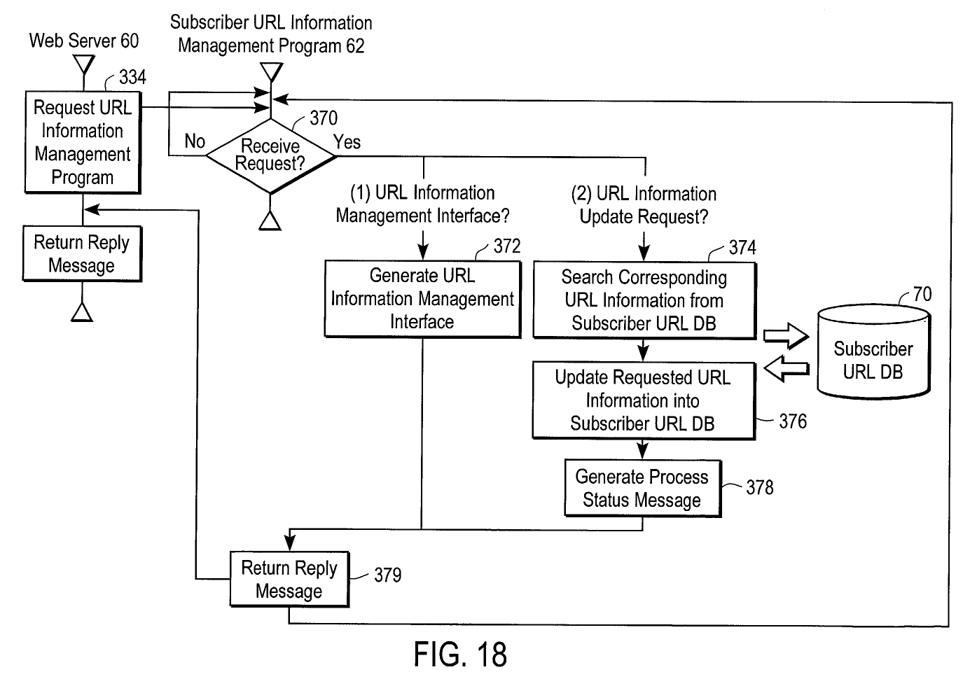

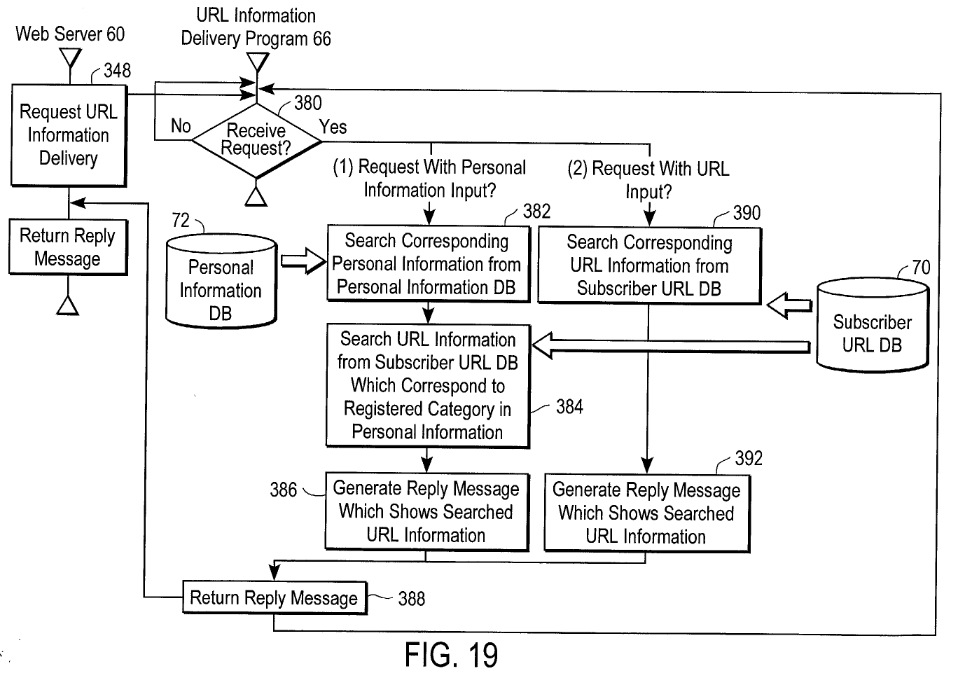

FIG. 14 illustrates a flowchart of representative processing performed by a web station in a specific embodiment according to the present invention. The web station 20 communicates with web tuner 10 and an operator. The web station operator executes various kinds of operations using web browser 68 interface as indicated by a step 300. The web browser 68 communicates with the web server 60 by HTTP, for example. The web tuner 10 user also communicates with the web server 60 by HTTP via web browser 164 of web tuner 10. The web server 60 receives a variety of different kinds of requests from the web tuner 10 and the web station 20. The web server 60 initializes programs requested by operators via web browser 68, or users of web tuner 10, via web browser 164 in a step 302. If the operator makes a URL information management request, the web server 60 initializes URL information reference and update processing in subscriber URL information management program 62 in a step 304. This processing is described herein below with reference to FIG. 18. If a user makes a URL information delivery request using the web tuner 10, the web server 60 initializes URL information search and delivery processing in URL information delivery program 66 in a step 306. This processing is described herein below with reference to FIG. 19. If a user or an operator makes a personal information management request, the web server 60 invokes personal information reference and update processing in personal information management program 62 in a step 308. This processing is described herein below with reference to FIG. 17.

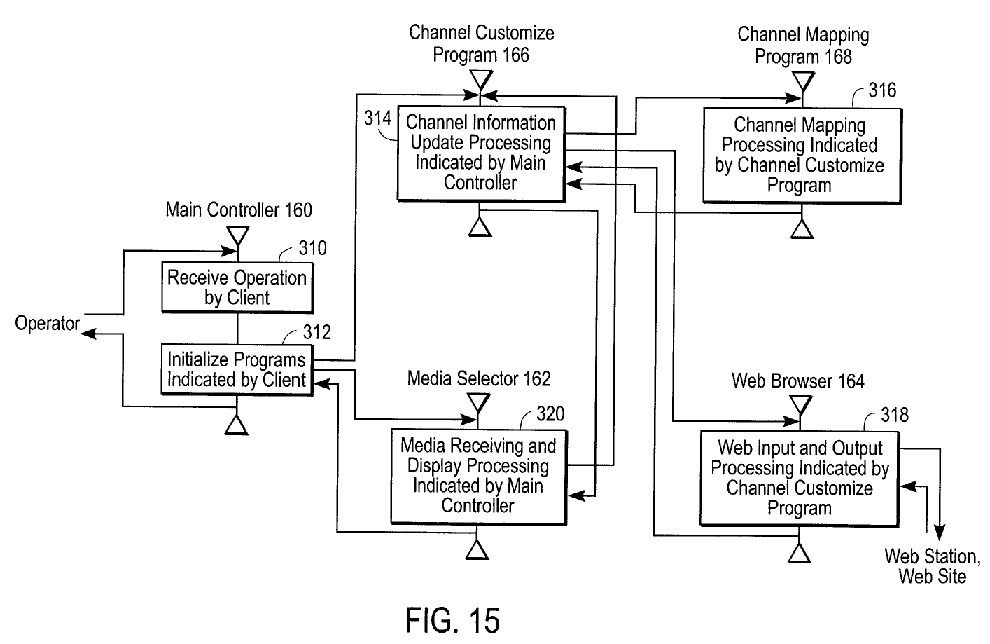

FIG. 15 illustrates a flowchart of representative processing performed by a web tuner in a specific embodiment according to the present invention. The web tuner 10 communicates with web station 20 and a user. The main controller program 160 accepts user's requests that are issued from the media control device 126 in a step 310. In a step 312, the main controller program 160 invokes programs to process the requests. The main controller program 160 accepts a variety of request types for processing. If a channel customize request is received, the main controller program 160 invokes the channel customize program 166 to perform channel information update processing that customizes the logical channel table in a step 314. The channel customize program 166 begins update processing by commanding the channel mapping program 168 to assign a logical channel value in a step 316, if needed. The channel customize program 166 communicates with the web station 20 using web browser 164, in order to synchronize customizing of the logical channel table with the web station 20 in a step 318.

Otherwise, if a media select request is received, then the main controller program 160 invokes the media selector program 162 to select a particular media stream to receive and to update a display of the media processing in a step 320. The media selector program 162 controls the media receiving devices shown in FIG. 7. If the user's request includes a logical channel value, then the media selector 162 orders channel customize program 166 to map it into actual media resource information in step 314.

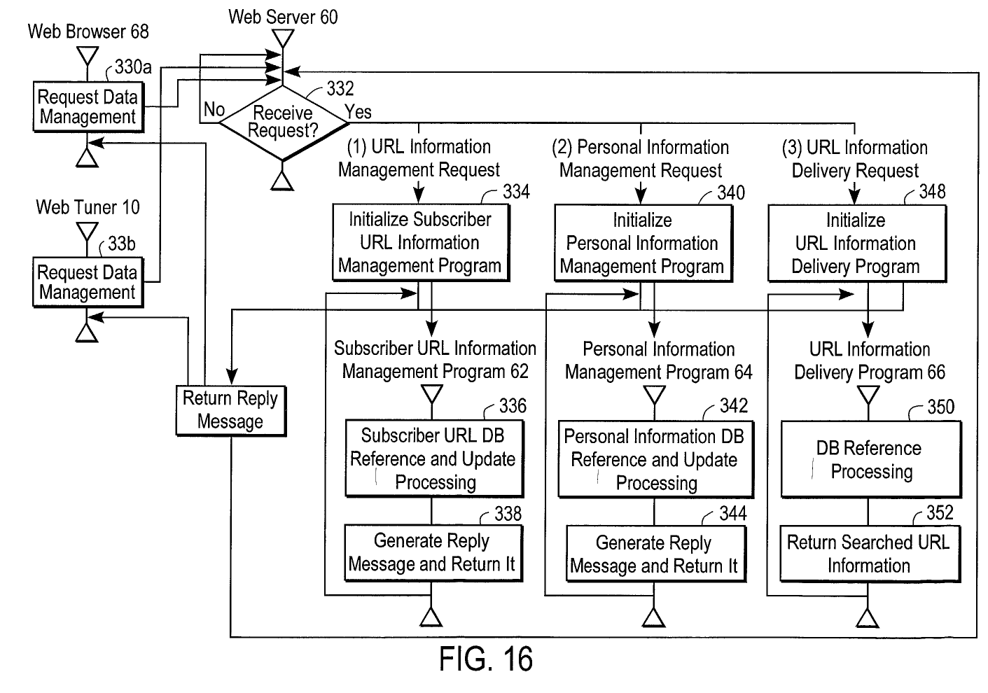

FIG. 16 illustrates a flowchart of representative processing performed by a web server in a web station in a specific embodiment according to the present invention. As described above with reference to FIG. 3, the web server 60 acts as an interface between the web station 20 and the web tuners 10. In this role, the web server 60 receives requests issued by users via the web browser 164 resident on the web tuner 10. Also described above with reference to FIG. 3, the web browser 68 acts as an interface for an operator at the web station 20. Requests from the operator are received by web server 60 from the web browser 68 resident on the web station 20. Thus, the web server 60 responds to requests from the web tuner 10 user, as well as for the local web station operator.

The web station operators input requests to the web server 60 using the web browser 68 in a step 330a. Requests from the web tuner 10 are input to the web server 60 in a step 330b. A variety of types of requests are processed by the web server 60. For example, a web station operator issues requests to manage the URL information stored in the subscriber URL information database 70. Both the web station 20 operator and the web tuner 10 users issue requests to manage personal information stored in the personal information database 72. Further, users at the web tuner 10 issue requests to the web station 20 to deliver URL information stored in subscriber URL information database 70. The web server 60 manages these types of requests, discriminates the type of the request, and instructs various programs to process the requests in a step 332. In a present specific embodiment, this processing is embodied in a CGI script that executes on web server 60.

If a URL information management request is received, the web server 60 invokes the subscriber URL information management program 62 for the purpose of maintaining subscriber URL database 70 in a step 334. The Subscriber URL information management program 62 commences subscriber URL database reference and update processing responsive to the request in a step 336, and returns a status to the web server 60 in a step 338. The processing of subscriber URL information management program 62 is described in further detail herein below with reference to FIG. 18.

If a personal information management request is received, the web server 60 invokes the personal information management program 64 for the purpose of maintaining personal information database 72 in a step 340. The personal information management program 64 performs personal information database reference and update processing responsive to the request in a step 342. In a step 344, the personal information management program 64 returns a status to the web server 60 in a step 344. The processing of the personal information management program 64 is described in further detail herein below with reference to FIG. 17.

If a URL information delivery request is received, the web server 60 invokes the URL information delivery program 66 for the purpose of returning the URL information requested by web tuner 10 user in a step 348. The URL information delivery program 66 performs subscriber URL database reference processing responsive to the request in a step 350, and returns a result to the web server 60 in a step 352. The processing of the URL information delivery program 66 is described in further detail herein below with reference to FIG. 19.

FIG. 17 illustrates a flowchart of representative processing performed by a personal information management program in a specific embodiment according to the present invention. As described above, the personal information management program 64 receives requests from both the web station 20 operator and the web tuner 10 user via the web server 60. The web server 60 issues various kinds of requests to the personal information management program 64 based upon the requests of the user or operator in step 340. The personal information management program 64 receives the request and discriminates the request by type in a step 360. In one type of request, the requestor needs to download a personal information management interface from the web station 20. The personal information management interface is displayed to the requestor using the web browser 68 in a step 362. Using the personal information management interface, the requesting user or operator can modify personal information in the personal information database 72.

Otherwise, if in step 360, the request is determined to be a request to update or change information in the personal information database 72, then the personal information management program 64 searches for requested personal information in the personal information database 72 in a step 364. If the information is found, then the personal information management program 64 updates the personal information database 72 as requested in a step 366. Otherwise, if the search failed to find the information, then a new personal information entry is created in the personal information database 72 in step 366. The new entry has a format illustrated by FIG. 4. The new entry is populated with the personal information contained in the request. Then, in a step 368, the personal information management program 64 generates a return message, and returns it to the invoking process in the web server 60 in a step 369.

FIG. 18 illustrates a flowchart of representative processing performed by a URL information management program in a specific embodiment according to the present invention. As described above, the URL information management program 62 receives various types of requests from web station 20 operator. The web server 60 issues various kinds of requests to the URL information management program 62 based upon the requests of the operator in step 334. The URL information management program 62 receives the request and discriminates the request by type in a step 370. In one type of request, the operator needs to download a URL information management interface from the web station 20. The URL information management interface is displayed to the operator using the web browser 68 in a step 372. Using the URL information management interface, the operator can modify URL information in the subscriber URL database 70.

Otherwise, if in step 370, the request is determined to be a modification request to update or change information in the subscriber URL database 70, then the URL information management program 62 searches for requested URL information in the subscriber URL database 70 in a step 374. If the information is found, then the URL information management program 62 updates the subscriber URL database 70 as requested in a step 376. Otherwise, if the search failed to find the information, then a new URL information entry is created in the subscriber URL database 70 in step 376. The new entry has a format illustrated by FIG. 5. The new entry is populated with the URL information contained in the request. Then, in a step 378, the subscriber URL information management program 62 generates a return message, and returns it to the invoking process in the web server 60 in a step 379.

FIG. 19 illustrates a flowchart of representative processing performed by a URL information delivery program in a specific embodiment according to the present invention. As described above, the URL information delivery program 66 receives various types of requests from web tuner 10 user. The web tuner 10 user issues requests to the web station 20, in order to receive information by either (1) personal information; or (2) URL itself. The web server 60 issues various kinds of requests to the URL information delivery program 66 based upon the requests of the user in step 348. The URL information delivery program 66 receives the request and discriminates the request by type in a step 380.

In one type of request, users input a personal ID number 82 (shown in FIG. 4), and receive URL information that is stored in the category to receive section 104 of the entry 80, which has been stored in the personal information database 72. Responsive to the URL information delivery request with personal information, the URL information management program 66 searches the personal information database 72 for an entry having corresponding personal information to the request in a step 382. If the entry is found in the database, the URL information management program 66 retrieves URL information from the category to receive field 104 in the entry. Next, the URL information management program 66 searches the subscriber URL database 70 for URL information that corresponds to the URL information retrieved from the category to receive field 104 in a step 384. This processing begins at a starting node, such as the root node 107 in the URL database 70 (see FIG. 5). From this node, the program visits child nodes in the tree, in order to find categories that match the category information for the user retrieved from the category to receive field 104 of the personal information database 72. In the example URL database entry 112 illustrated by FIG. 5, the program begins searching with the root node 107. The program finds the English node 108 and determines that it matches one or more entries within the category to receive field 104 in the corresponding entry 80 of personal information database 72. The program then visits child nodes of the English node 108, and finds that the movie node 109 matches one or more entries in the category to receive field 104. Accordingly, the program selects one or more child entries within the movie node 109, such as movie node 112, to forward to the user making the request. The movie node 112 comprises a corresponding URL 113 that enables the user to retrieve media from the node. Further, the movie node 112 comprises a plurality of other URL's for related links 114, 115. If both search processes are successful, then, in a step 386, the URL information management program 66 generates a reply message that includes the one or more URLs retrieved in step 384. The reply message is provided to the invoking web server 60 in a step 388. Accordingly, specific embodiments enable the user who is registered with the web station 20 to receive media from favorite web resources using a one click operation.

Otherwise, if in step 380, the request is determined to be a request to receive information for a specific URL, then the URL information delivery program 66 searches for requested URL information in the subscriber URL database 70 in a step 390. If the URL is found, then, in a step 392, the URL information management program 66 generates a reply message that includes a description and related links information. For example, if the URL information delivery program 66 searches the subscriber URL database 70 for a URL, such as http://www.movie.com/action.html, as illustrated in FIG. 5, and movie node 112 has the URL 113 that matches the URL being searched, then the related links information 114, 115 shown in FIG. 5 for the entry 112 is provided in the reply message. The reply message is provided to the invoking web server 60 in a step 388.

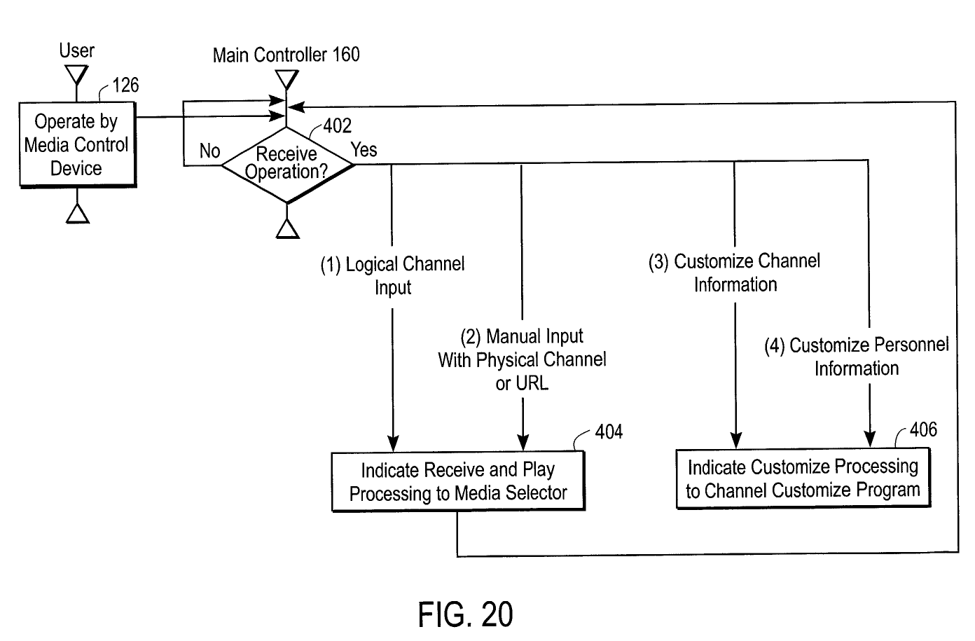

FIG. 20 illustrates a flowchart of representative processing performed by a main controller program in a web tuner in a specific embodiment according to the present invention. As described above, the users input their operations using the media control device 126 as described with reference to FIG. 8. Users' requests include a variety of types of operations, including: (1) input of a logical channel value, such as “1”, “0201”, “1001”, which are mapped into real media information such as “channel 51”, “905 MHz”, and “http://www.news.com/news/;” (2) input of real media information in order to receive media that is not registered in a logical channel table 200; (3) input of requests to customize the logical channel table 200; and (4) input of personal information to be stored in the personal channel information database 170.

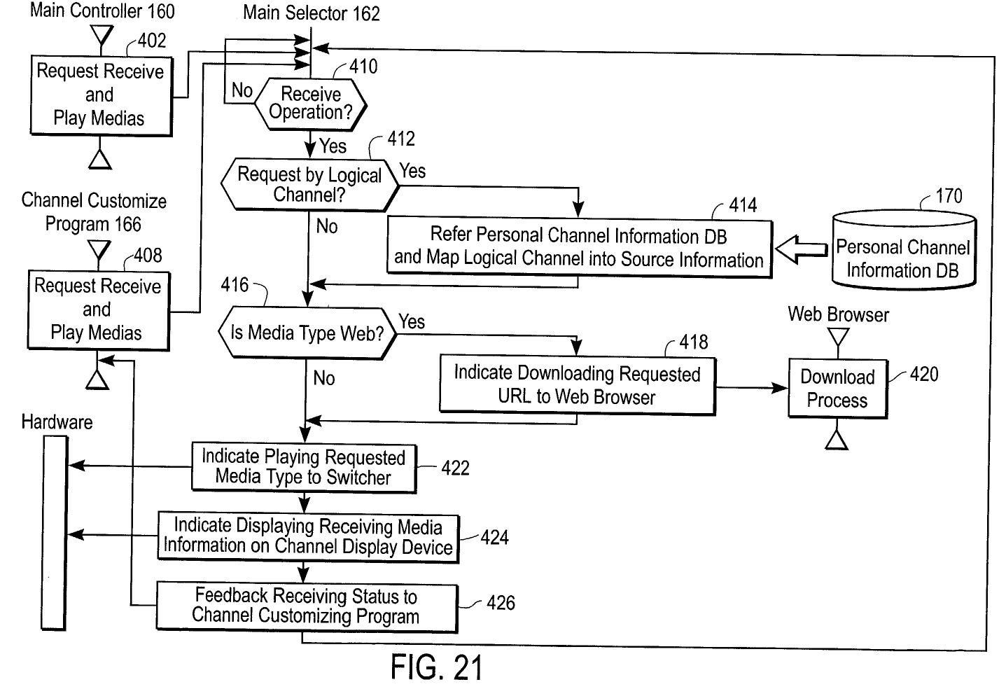

The web tuner 10 invokes various programs to process the requests of the users, which are received from the media control device 126 in a step 402. If the user makes a logical channel input, the main controller program 160 invokes the media selector program 162 to map the logical channel into real media information and to perform play processing to the media selector program 162 in a step 404. This processing is described herein below with reference to FIG. 21. If the user inputs real media, the main controller program 160 commands the media selector program 162 to play it, i.e., provide a media stream from the requested source, in step 404. Otherwise, if the user makes a request to customize channel information, or personal information, then the main controller 160 commands the channel customize program 166 to process the request in a step 406.

FIG. 21 illustrates a flowchart of representative processing performed by a media selector program in a web tuner in a specific embodiment according to the present invention. The media selector program 162 accepts inputs from main controller 160, in a step 404, and channel customize program 166, in a step 408. In a step 410, the media selector program 162 determines if a media play request has been received. If the request is proper, then, the media selector program 162 determines whether the request comprises of a logical channel input or a real media information in a step 412. If a request including a logical channel input is received, then the media selector program 162 maps the logical channel information to real media information in a step 414. The media selector program 162 refers to the logical channel table 200 stored in personal channel information database 170, in order to map the logical channel input into real media source information in the step 414. Otherwise, or in any event, in a step 416, the media selector program 162 determines if the type of the media information is web. If the information is from the web, then the media selector program 162 downloads the requested URL by web browser 164 in steps 418 and 420. Next, the media selector program 162 indicates the requested media type to the switcher device 132 in order to switch the output to play media of the requested type in a step 422. The switcher device 132 provides A/V output from one of the input receiving devices, such as TV tuner 140, and radio tuner 142. Then, in a step 424, information about the media selected is displayed using the channel output device 128. Additionally, in a step 426, status of the receiving process is fed back to the invoking program.

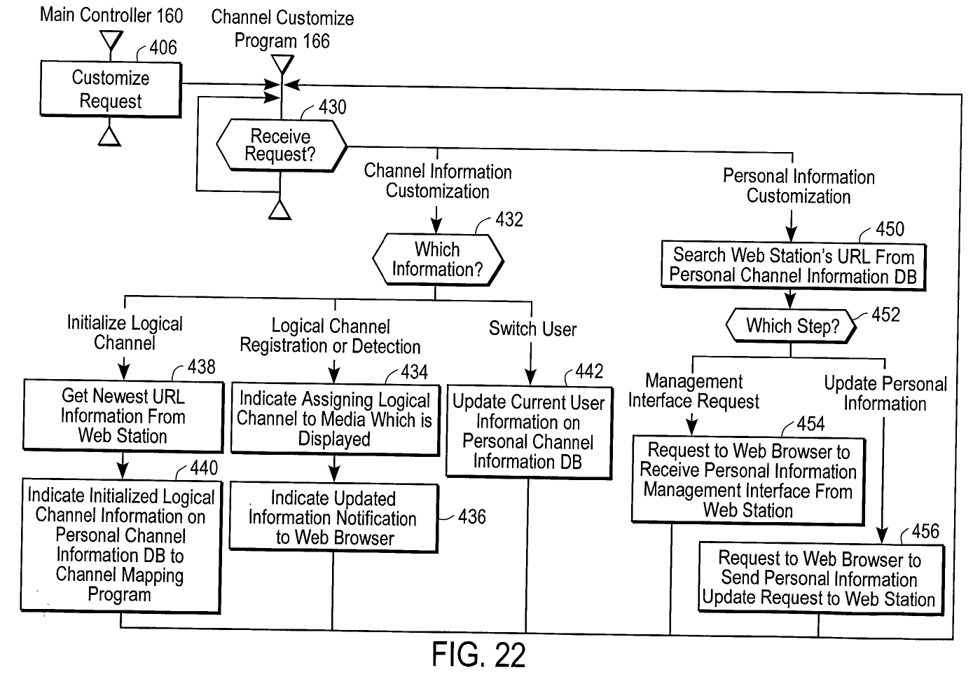

FIG. 22 illustrates a flowchart of representative processing performed by a channel customize program in a specific embodiment according to the present invention. he channel customize program 166 enables users to customize information stored in the personal channel information database 170. The channel customize program 166 accepts a variety of types of requests as input in a step 430. These requests include a (1) logical channel customization request from the web tuner 10; and (2) a personal information customization request to customize personal information stored in the web station 20.

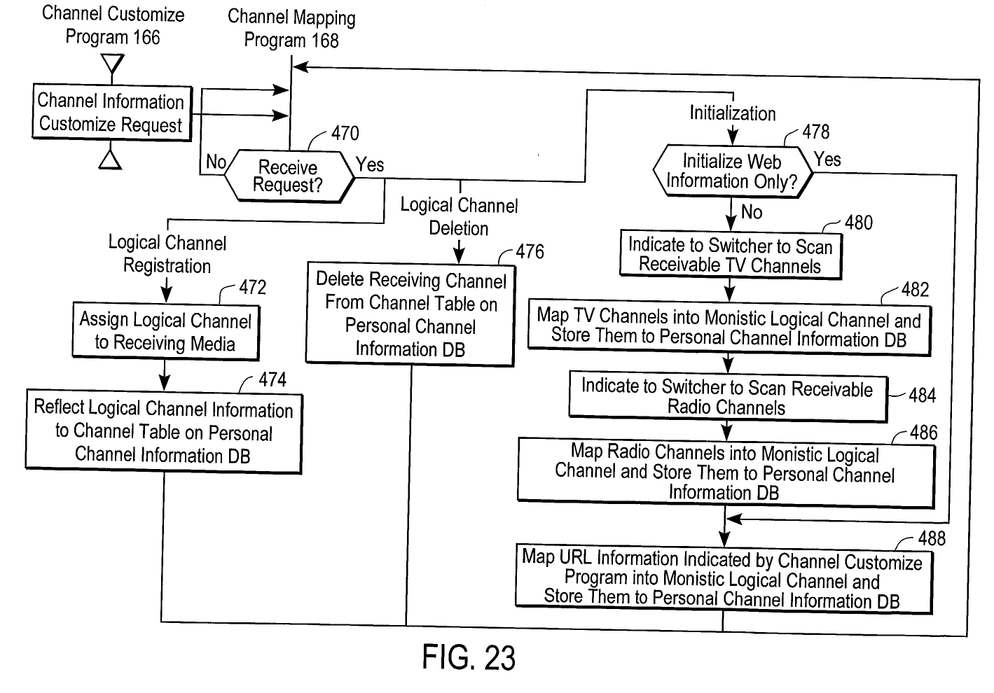

Channel customization requests are input by users via a user interface such as the channel customize interface screen 250 in FIG. 12. Users can add or delete logical channels to or from the logical channel table 200, initialize logical channel information, and switch users by using this interface. In a step 432, the channel customize program 166 determines from the type of request, which program to invoke. If the user makes a request to add a logical channel, then the channel customize program 166 commands the channel mapping program 168 to assign a logical channel value to a source of the requested media source in a step 434. Analogously, in the case that deletion of a logical channel is requested, the channel customize program 166 commands the channel mapping program 168 to delete the URL for the media stream being received. In both of these cases, the channel mapping program 168 modifies the channel information by updating the logical channel table 200. This processing is described herein below with reference to FIG. 23. The web station 20 may be notified of modifications to the logical channel table 200, in order to synchronize the logical channel table 200 between the personal information database 72 of web station 20 and the personal information database 170 of the web tuner 10, in a step 436.

If the user requests to initialize a logical channel, the channel customize program 166 retrieves the newest URL information from the web station 20 in a step 438. Then, in a step 440, the channel customize program 166 commands the channel mapping program 168 to initialize logical channel information in the personal channel information database 170 for the newest URL information retrieved in step 438. If the user requests to switch the current user via the channel customize interface 250 in FIG. 12, the channel customize program 166 sets the current logical channel table for the requested user by updating the current user information in the personal channel information database 170 in a step 442.

Otherwise, if the user has requested personal information customization, then the channel customize program 166 searches the personal channel information database 170 for web station URLs used to communicate with the web station 20 in a step 450. The user downloads an interface from the web station 20 to the web tuner 10 in order to modify the URL information searched. In a step 452, it is determined whether the user needs to download the interface from the web station 20. If so, then in a step 454, the channel customize program 166 issues a request to the web browser 164 to receive an interface to the web station 20. The web station 20 accepts the request and returns the channel customization interface in steps 360, 362 of FIG. 17. The web tuner receives the interface and displays the interface via the A/V output I/F 150.

The web tuner 10 user may now input personal information customization requests using the interface. The channel customization program 166 accepts these requests, and issues update requests to the web station 20 via the web browser 164 in a step 456. The web station 20 accepts these requests, and updates the personal information stored in personal information database 170 in steps 364, 365 of FIG. 17.

FIG. 23 illustrates a flowchart of representative processing performed by a channel mapping program in a specific embodiment according to the present invention. The channel mapping program 168 accepts requests to store a logical channel associated with a media source into logical channel table 200 or to delete a logical channel from the logical channel table 200. The channel mapping program 168 determines the type of the request and invokes appropriate processing for the request in a step 470. If registration is requested, then the channel mapping program 168 determines a logical channel value that should be assigned to requested media in a step 472. Then, this information is reflected into the logical channel table 200 in the personal channel information database 170 in a step 474. If the request is to delete a logical channel, the channel mapping program 166 discards the logical channel value from logical channel table in a step 476.

Otherwise, if the request is to initialize the channel table 200, then in a step 478, it is determined whether only the web information is to be initialized. If in step 478, it is determined that non-web media will be initialized, then in a step 480 the switcher device 132 is instructed to scan for television channels sourcing receivable media. Then, in a step 482, television channels found in step 480 are mapped into a plurality of logical channels and stored in the personal channel information database 170. Next, in a step 484, the switcher device 132 is instructed to scan for radio frequencies sourcing receivable media. Then, in a step 486, radio frequencies found in step 484 are mapped into a plurality of logical channels and stored in the personal channel information database 170. Next, in a step 488, URL information indicated the channel customize program 166 is mapped into a plurality of logical channels and stored in the personal channel information database 170. Alternatively, if, in step 478, it is determined that only web information is to be initialized, then processing continues with step 488, skipping steps 480-486.

The present invention provides in specific embodiments a global media service system, methods, apparatuses, and computer software to control multiple heterogeneous types of media using a single channel model. In specific embodiments, users are able to operate web and other media more easily than with conventional approaches. For example, in a specific embodiment, users input a logical channel “1” in order to receive “channel 51” of TV media, and a logical channel “101” to receive radio programs, a logical channel “1001” to receive http://www.news.com/news, and so forth.

Users can refer to their own logical channel information even if the user is away at a remote location. The user can refer to personalized logical channel information from virtually anywhere that the user has access to a web station. For instance, if a user customizes his or her own logical channel as a “favorite bookmark”, then the user can use the logical channel in a hotel from which the web station may be accessed.

The present invention provides navigation directed web browsing in various specific embodiments. Related content sources are displayed on a channel display device while a user browses a web resource. Accordingly, users can refer to content that is associated with current content. For example, while a user is browsing movie information on the web, an “actor's profile” site and a “making history” site can be introduced on a channel display device in a specific embodiment. The user can access these sites with a mere single click operation.

The preceding has been a description of the preferred embodiment of the invention. It will be appreciated that deviations and modifications can be made without departing from the scope of the invention, which is defined by the appended claims.

What is claimed is:

1. A web tuner apparatus comprising:
a first means for storing at least one of a plurality of relationships between a user definable identifier for a media source and a source of a media stream;
a means for remotely controlling receiving, and selecting media, and for receiving an input of said at least one of a plurality of relationships between a user definable identifier and a media source;
a means for displaying information about media sources and receiving input of a selection of a media stream to be played;
a means for selecting one of said at least one of a plurality of types of media to receive based upon said input of a selection of a media stream to be played;
a means for receiving at least one of a plurality of types of media; and
an output interface means for providing a media output selected by said means for selecting.

2. The apparatus of claim 1, wherein said media includes at least one selected from cable television, television broadcast, radio broadcast, world wide web, and Internet based information.

3. The apparatus of claim 1, wherein said at least one of a plurality of relationships between a user definable identifier and a media source comprises a logical channel table.

4. The apparatus of claim 1, wherein said means for remotely controlling receiving, and selecting media comprises a channel service user interface for a plurality of media types, wherein said sources of media are mapped into logical channel values.

5. The apparatus of claim 1, further comprising:
a network interface means for providing connectivity to a server.

6. A web station apparatus comprising:
a means for storing subscriber URL information, said information comprising at least one of a plurality of hierarchical categories, said categories providing organization for identifiers of media content for at least one of a plurality of sources of media streams;
a network interface means for providing connectivity to an Internet;
a means for searching said hierarchical categories in said subscriber URL information to find media having content of interest; and
a means for providing said content of interest to a user.

7. The web station apparatus of claim 6, wherein said media further comprises at least one selected from cable television, television broadcast, radio broadcast, world wide web, and Internet based information.

8. The web station apparatus of claim 6, wherein said means for storing subscriber URL information further comprises at least one of a plurality of relational categories that organize said media content.

9. The web station apparatus of claim 6, further comprising a means for storing personal channel information, wherein a personal channel table stored locally at a user site is mirrored by said means for storing personal channel information, enabling users to reference said channel table from remote locations.

10. A system comprising:
a web station;
a web tuner; and
a network interface providing connectivity to an Internet; and enabling the web station to be accessed by the tuner;
wherein the web tuner maintains personal channel information for at least one of a plurality of users; and wherein the web station maintains a copy of the said personal channel information for at least one of a plurality of users.

11. A computer-readable storage medium storing program code for causing a computer to:
retrieve at least one of a plurality of identifiers for a media source of media streams to be played;
display said at least one of a plurality of identifiers for a media source of media streams to be played;
select, via a user interface, a media stream to be played from at least one of a plurality of media to receive, said selecting performed by selecting one from said at least one of a plurality of identifiers for a media source of media streams to be played;
command a switch to select said media stream to be played from among said at least one of a plurality of types of media received by at least one receiver; and
output said media stream to be played via an output interface.

12. The computer-readable storage medium of claim 11, wherein said identifiers comprise user definable identifiers, said user definable identifiers being stored in a first personal information store.

13. The computer-readable storage medium of claim 12, wherein the program code further causes the computer to:
forward from a first location a copy of said first personal information store to a server;
create at said server a copy of said first personal information store; and
access said copy of said first personal information store to retrieve said at least one of a plurality of user definable identifiers for a media source of media streams to be played from a second location at a later time.

14. The computer-readable storage medium of claim 12, wherein the program code further causes the computer to:
store a user definable identifier for a media source of a media stream being played currently, said user definable identifier being stored in a first personal information store.

15. The computer-readable storage medium of claim 11, wherein said identifiers are stored in a subscriber URL information store.

16. The computer-readable storage medium of claim 15, wherein the program code further causes the computer to:
store an identifier for a media source, said identifier being stored in a subscriber URL information store, said subscriber URL information store comprising at least one of a plurality of hierarchical categories, said categories providing organization for identifiers of media content.

17. The computer-readable storage medium of claim 15, wherein the program code further causes the computer to:
select via a user interface a related media stream to be played, said related media stream to be played having content related to said media stream to be played, said selecting performed by selecting one from at least one of a plurality of URL identifiers for said media stream to be played; and thereupon selecting a second URL identifier corresponding to said related media stream to be played.

18. The computer-readable storage medium of claim 11, wherein said media further comprises media of disparate types, wherein said types of media include at least one selected from cable television, television broadcast, radio broadcast, world wide web, and Internet based information.

19. The computer-readable storage medium of claim 12, wherein the program code further causes the computer to:
receive an identity of a user; and
provide a plurality of user definable identifiers for said user.

20. The computer-readable storage medium of claim 11, wherein the program code further causes the computer to:
scan an input source for at least one of a plurality of receivable television channels;
map said at least one of a plurality of receivable television channels to at least one of a plurality of identifiers;
scan an input source for at least one of a plurality of receivable radio frequencies;
map said at least one of a plurality of receivable radio frequencies to at least one of a plurality of identifiers;
scan an input source for at least one of a plurality of internet based media sources; and
map said at least one of a plurality of internet based media sources to at least one of a plurality of identifiers.
